(19) United States
(12) Patent Application Publication
(10) Pub. No.: US 2005/0258200 A1
(43) Pub. Date: Nov. 24, 2005

(54) Carrier assembly for vehicles

(76) Inventor: Andrew P. Scola, Essex, MA (US)

Correspondence Address: DONALD N. HALGREN, 35 Central Street, Manchester, MA, 01944, US

(21) Appl. No.: 10/852,468

(22) Filed: May 24, 2004

(51) Int. Cl. B62D 43/00; B62D 25/20

(52) U.S. Cl. 224/42.13; 224/488; 224/509

(57) ABSTRACT

A carrier assembly for attachment to a utility vehicle for the safe carrying and enclosure of a removable door of the utility vehicle such as a Jeep™. The carrier assembly comprises a left support panel and a right support panel attachable in a parallel, spaced apart manner to a rear body portion of the vehicle to define an enclosure space therebetween. A swingable support frame is pivotally secured adjacent one of said support panels to provide a rearward securement to the enclosure space. A mounting bracket is arranged on each opposing face of the support panels so as to engage and secure a vehicle door or storage member between the spaced apart panels.

### BACKGROUND OF THE INVENTION

1. Field of the Invention

The present invention relates to modular assemblies for the attachment to the back of a utility vehicle, most specifically for carrying components of a utility vehicle on the rear end of that utility vehicle.

2. Prior Art

One of the more popular utility vehicles in the United States is one sold under the trademark JEEP and has had a number of corporate owners over the past few decades. The basic style remains generally the same. It is typically a four wheel drive vehicle with a removable/foldable top and a left side door and a right side door which are also removable with vertically disposed rear body panels.

This vehicle has a generally small body configuration. When someone wants to remove the side doors there is an inconvenience in finding a place to store them when all the seats in this vehicle are being utilized.

It is an object of the present invention to overcome the disadvantages of the prior art.

It is a further object of the present invention to provide an enlarged storage capacity for the doors of a Jeep or other items which may be carried along with that Jeep vehicle.

It is yet a further object of the present invention to provide a modular assembly which is attachable to a utility vehicle such as a Jeep, which assembly will safely store and securely hold doors or other desirable components to take within during the vehicle's use.

### BRIEF SUMMARY OF THE INVENTION

The present invention comprises a carrier assembly for securably enclosing removable vehicle side doors and holding them against the vertical panels at the vehicle's rear end, which carrier assembly is best suited for attachment to “Jeep” vehicles. Jeep vehicles typically have a boxlike rear body portion having a vertically disposed rear end comprising a left and a right rear panel. A flat rear door is typically arranged between the left and right rear panels and is typically hingedly attached to the right rear panel. A tail light is typically disposed on each rear panel as well. The carrier assembly of the present invention includes a generally Z-shaped left support frame and a generally Z-shaped right support frame. Each left and right support frame is attached to the lower side of the frame at the rear of the Jeep body. An elongated left support panel is arranged on the left support frame and is also secured to the left rear panel on the rear of the Jeep.

A right support panel is secured to the right hand side of the taikgate. The right support panel in a plan view, is of L-shaped. The right support panel thus includes a right panel attachment plate. The right panel attachment plate is boltable to the rear door of the Jeep. When the tailgate of the Jeep is openable, the right support panel pivots to the right as the tailgate is opened.

A spare tire support frame is hingedly attached to the distal end of the left support frame. The spare tire support frame has a distal end which engages a catch on the distal end of the right support frame attached to the right hand end of the bumper on the rear of the Jeep vehicle. An arm arrangement extends upwardly from a mid-portion of the spare tire support frame to support a spare tire panel. The spare tire panel, as the name implies, has the spare tire which is mountable thereon. The spare tire support panel by virtue of its being supported on the distal end of the left support frame and the distal end of the right support frame, is spaced rearwardly from the rear door of the Jeep vehicle. This spacing provides a location for components of the Jeep to be so carried. Such components may include the left door and the right door which are typically removable from a Jeep vehicle.

A door latch receiving bracket is attached to the inward side of the left support panel. The door latch receiving bracket is generally of U-shape and is pivotable from a vertical position to a horizontal position. The door latch receiving bracket is attached relatively closely to the left rear panel on the rear side of the Jeep vehicle. A pair of left door receiving pintles are secured to the rearwardmost edge of the inner side of the left support panel.

A door latch receiving bracket for the left door is attached to the rearward edge of the right support panel extending from the rear door of the Jeep vehicle. A pair of right door receiving pintles are attached adjacent the forward edge of the right support panel. The receiving pintles arranged on the respective left and right support panels are arranged to receive the hinge pins which are part of the left and right doors of a Jeep vehicle. The generally U-shaped downwardly swingable door latch receiving brackets are arranged to receive the catch on their respective doors that are placed between the left support panel and the right support panel.

The carrier assembly for Jeep vehicles may comprise a kit which is attachable to the rear body panels and bumper of a Jeep vehicle by bolt attachment thereto.

In a further embodiment of the present invention a stowable enclosure box may be supported between the left support panel and the right support panel and between the spare tire panel and the rear door of the Jeep. The storage container in this embodiment has a pair of downwardly projecting pins disposed on each lateral side. Each downwardly disposed pin is arranged to fit into the upper left support pintle and the upper right door support pintle on the respective left support panels on the rear of the Jeep vehicle. Such pin and pintle securement permits a large storage capacity which is secure and yet is removable from the rear of the Jeep by its owner. The cargo carried between the left support panel and the right support panel may in one embodiment, be latched nad/or locked therein by a latch and/or locking engagement of the spare tire support frame to the right support frame attached to the right hand side of the rear bumper of the Jeep vehicle. A frame may be arranged between the side panels to receive and lock in place skis, snowboards or other athletic equipment.

The invention thus comprises a carrier assembly for attachment to a utility vehicle for the safe carrying and enclosure of a removable door of the utility vehicle. The carrier assembly may comprise a left support panel and a right support panel attachable in a parallel, spaced apart manner to a rear body portion of the vehicle to define an enclosure space therebetween. A swingable support frame is pivotally secured adjacent one of the support panels to provide a rearward securement to the enclosure space. A mounting bracket arrangement is disposed on each opposing face of the support panels so as to engage and secure a vehicle door or storage member between the spaced apart panels. The mounting bracket arrangement preferably comprises a pair of vertically spaced apart pintles, each of the pintles arranged to receive a hinge pin of a door or component of the vehicle. The mounting bracket arrangement may also include a pivotable latch. The pivotable latch being arranged to engage a door handle clip of the removable door. The swingable support frame is preferably arranged to carry a spare tire of the vehicle. The assembly may include a left support frame and a right support frame which are attachable to a portion of the frame of the vehicle for lower support of the left and right support panels. The right support frame is preferably of “L” shape. The right support frame may include a right panel attachment plate. The right panel attachment plate being attachable to a tailgate of the vehicle. The right support frame is attached to the vehicle frame and may have a swingable support frame locking means thereon, to secure and lock the swingable support frame to the support frame on the bumper. The storage member may comprise a storage box which is securable to the left and the right support panels. The storage box has an elongated pin arranged on each side thereof, so as to engage the mounting bracket arrangements on the opposing faces of each of the left and the right support panel. The elongated pin on each side of the storage box are preferably arranged adjacent diagonally opposed corners of the box. The storage box may in a further embodiment comprise a frame disposed between the left and the right support panels for pinchably receiving athletic equipment therebetween.

The invention also comprises a method of storing doors of a vehicle on a back portion of the vehicle, comprising: attaching a pair of panels off of a rear portion of the vehicle; attaching a set of pintles onto each of the panels; and placing a hinge pin of the door into one of the pintles to support the door between the panels.

### BRIEF DESCRIPTION OF THE DRAWING

The objects and advantages of the present invention will become more apparent when viewed in conjunction with the following drawings, in which:

FIG. 1 is a perspective view of the carrier assembly attached to the rear end of a Jeep vehicle;

FIG. 2 is a side elevational view of the spare tire support frame;

FIG. 3 is a side elevational view of the rear end of a Jeep vehicle with the carrier assembly attached thereto;

FIG. 4 is a view similar to FIG. 3 with a spare tire shown attached to the spare tire panel;

FIG. 5 is a elevational view of the rear of a Jeep vehicle with the carrier assembly attached but without the spare tire support frame, for convenience of viewing;

FIG. 6 is a view similar to FIG. 5 showing a pair of Jeep doors attached between the left and right support panels of a carrier assembly;

FIG. 7 is a plan view of the rearward end of a Jeep vehicle and a carrier assembly thereattached with the spare tire support frame and spare tire shown in an opened configuration with the front doors assembled between the side support panels;

FIG. 8 is a view similar to FIG. 7 with the spare tire support frame and tire thereon shown in its closed configuration;

FIG. 9 is a side elevational view of the rear of a Jeep showing portions of the door latch receiving brackets enlarged for ease of viewing;

FIG. 10 is a side elevational view of the rear of a Jeep with the carrier assembly attached thereon and an enclosure box shown relative thereto in an exploded configuration;

FIG. 10A is a plan view of the enclosure box shown in FIGS. 10 and 11;

FIG. 11 is a view similar to the view shown in FIG. 10 with the enclosure shown attached to the respective support panels and secured thereto;

FIG. 12 is a view similar to FIG. 10 showing a pair of support bars in an exploded representation;

FIG. 13 is a view similar to FIG. 10 showing sports equipment carried on a ski holder attached to the support bars of FIG. 12; and

FIG. 14 is a plan view of a ski holder frame attached to the support bars, showing it set up without any skis secured thereto.

### DETAILED DESCRIPTION OF THE PREFERRED EMBODIMENTS

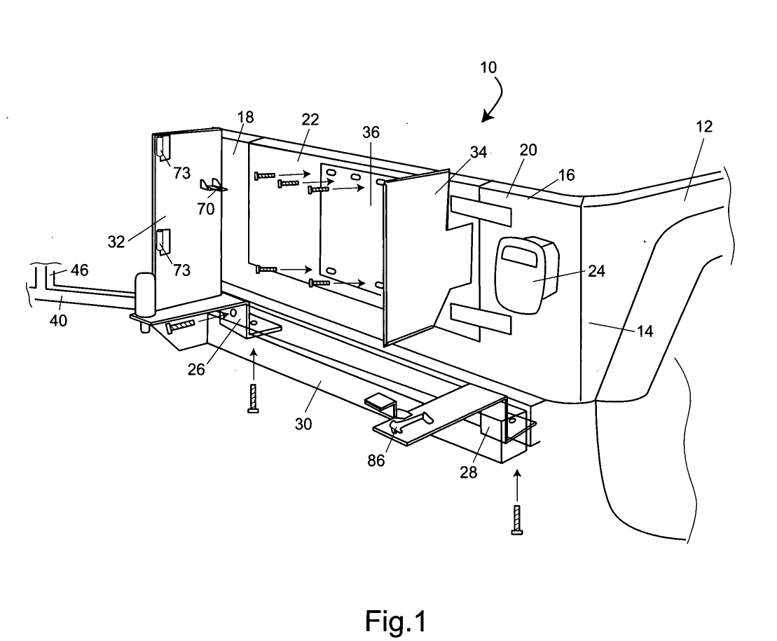

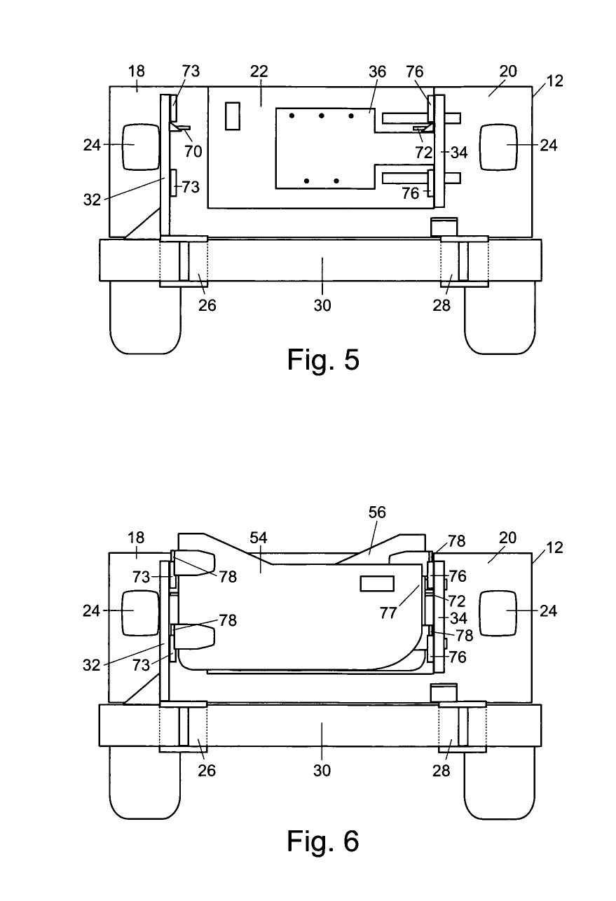

Referring now to the drawings in detail, and particularly to FIG. 1, there is shown the present invention which comprises a carrier assembly 10 for securably enclosing removable vehicle side doors and holding them against the vehicle's rear end, which carrier assembly 10 is best suited for attachment to “Jeep™” vehicles 12. Jeep vehicles 12 typically have a boxlike rear body 14 portion having a vertically disposed rear end 16 comprising a left rear panel 18 and a right rear panel 20. A flat rear door 22 is typically arranged between the left and right rear panels 18 and 20 and is typically hingedly attached to the right rear panel 20. A tail light 24 is typically disposed on each rear panel 18 and 20 as well. The carrier assembly 10 of the present invention includes a generally Z-shaped left support frame 26 and a generally Z-shaped right support frame 28. Each left and right support frame 26 and 28 is attachable to the lower side of the frame 30 on the rear end 16 of the Jeep body 14, as may be seen in FIGS. 1, 3, 4, 5 and 6. An elongated left support panel 32 is arranged on the left support frame 26 and is also secured to the left rear panel 18 on the rear of the Jeep 12, as shown in FIGS. 1, 3, 4, 5, 6, 7 and 8.

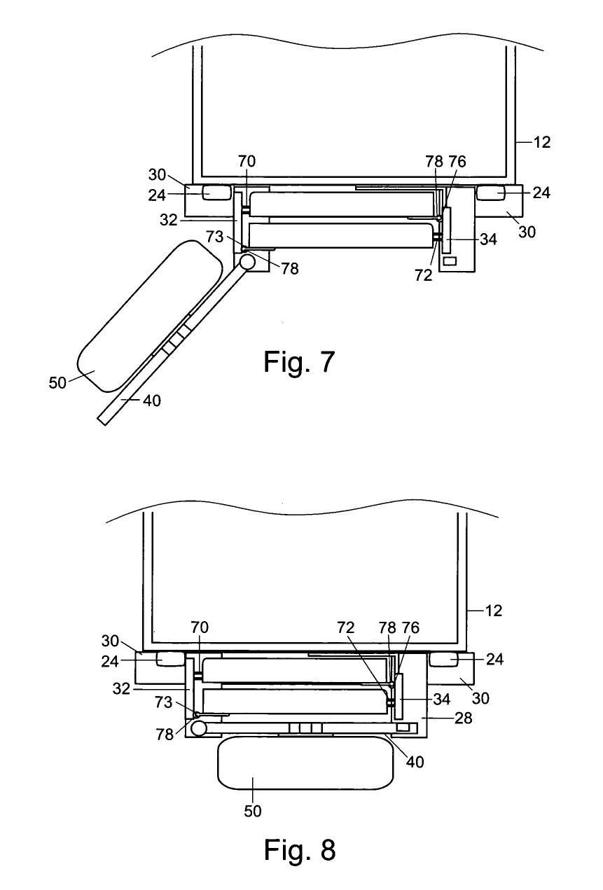

A right support panel 34 is secured to the right hand side of the rear door 22. The right support panel 34, in a plan view, is of L-shape, as may be envisioned in FIG. 1, and as is shown in FIGS. 7 and 8. The right support panel 34 thus also comprises a right panel attachment plate 36. The right panel attachment plate 36 is boltable to the rear door 22 of the Jeep 12, as is best represented in FIG. 1. When the rear door 22 of the Jeep 12 is opened, the right support panel 34 pivots to the right as the rear door 22 is opened.

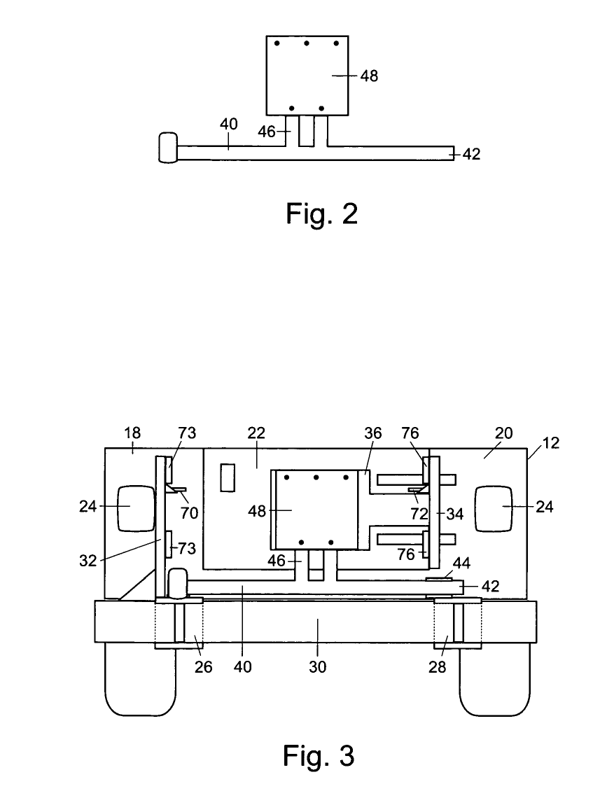

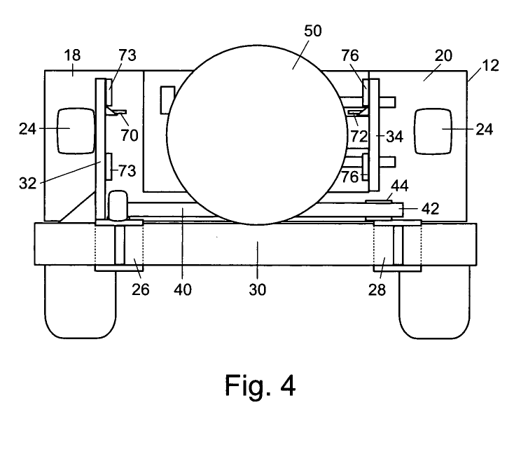

A spare tire support frame 40, partially shown in FIG. 1, is hingedly attached to the distal end of the left support frame 26, which may also be seen in FIGS. 3, 4, 5, 6, 7, and 8. The spare tire support frame 40 is shown by itself in a plan view in FIG. 2. The spare tire support frame 40 has a distal end 42 which engages a catch 44 on the distal end of the right support frame 28, attached to the right hand end of the frame 30, (which may in a alternative embodiment be a bumper), on the rear of the Jeep vehicle 12. An arm arrangement 46 extends upwardly from a mid-portion of the spare tire support frame 40 to support a spare tire panel 48. The spare tire panel 48 has the spare tire 50 which is mountable thereon, as is represented in FIGS. 4, 7 and 8. The spare tire support panel 48, by virtue of its being supported on the distal end of the left support frame 26 and the distal end of the right support frame 28, is thus spaced rearwardly away from the rear door 22 of the Jeep vehicle 12. This spacing provides a location for components of the Jeep 12 to be carried therebetween. Such components may include the left door 54 and the right door 56, as represented in FIGS. 6, 7 and 8, which doors 54 and 56 are typically removable from a Jeep vehicle 12.

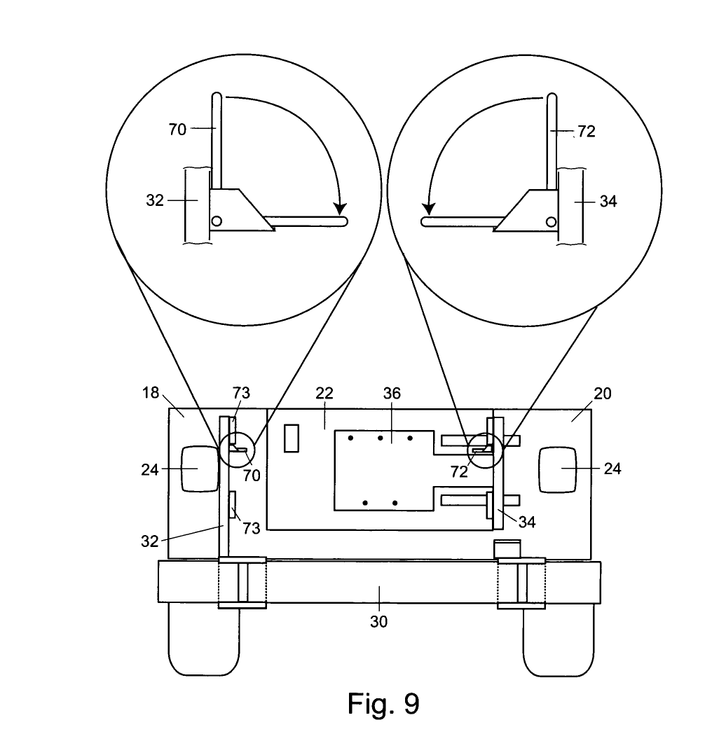

A door latch receiving bracket 70 is attached to the inward side of the left support panel 32, as is represented in FIGS. 1, 3, 4, 5, 6, 7 and 8. The door latch receiving bracket 70 is generally of U-shape and is pivotable from a vertical position to a horizontal position, as is shown more specifically in FIG. 9. The door latch receiving bracket 70, as shown in FIGS. 1, 7 and 8, is attached relatively closely to the left rear panel 18 on the rear side of the Jeep 12. A pair of left door receiving pintles 73 are secured to the rearwardmost edge of the inner side of the left support panel 32, as shown in FIGS. 1, 7 and 8.

A door latch receiving bracket 72 for the left door 54 is attached to the rearward edge of the right support panel 34 extending from the rear door 22 of the Jeep vehicle 12, as shown in FIGS. 3, 4, 5, 6, 7, 8, 9 10 and 11. A pair of right door receiving pintles 76 are attached adjacent the forward edge of the right support panel 34. The receiving pintles 73 and 76 arranged on the respective left and right support panels 32 and 34 are arranged to receive the hinge pins 78 which are part of the left and right doors 54 and 56 of a Jeep vehicle 12, as best represented in FIGS. 6, 7 and 8. The generally U-shaped downwardly swingable door latch receiving brackets 70 and 72 as best shown in FIG. 9, are arranged to receive the catch 77 on their respective doors 54 and 56, that are placed between the left support panel 32 and the right support panel 34, as shown in FIGS. 6, 7 and 8.

The carrier assembly 10 for Jeep vehicles 12 may be comprised of a kit comprising the aforementioned, the components of which are attachable to the rear body panels and bumper of a Jeep vehicle by a bolt attachment thereto as shown herewithin.

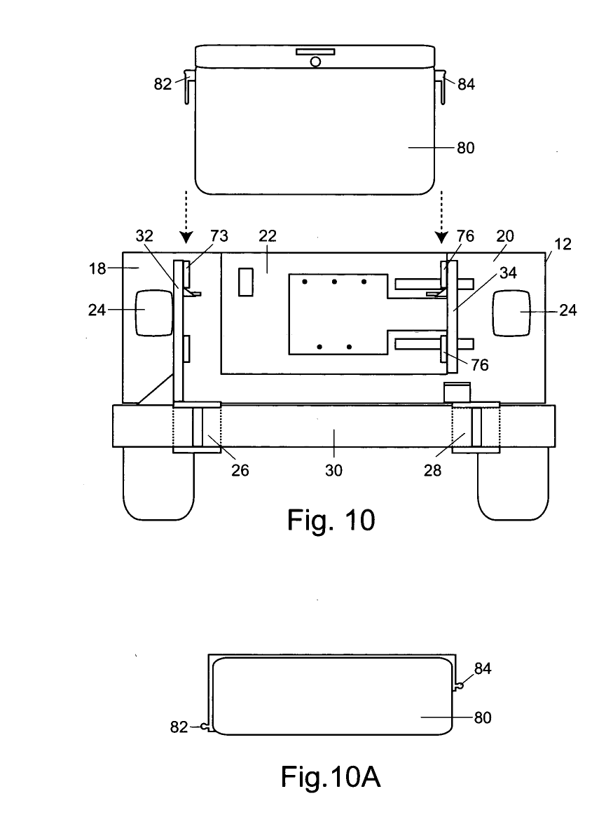

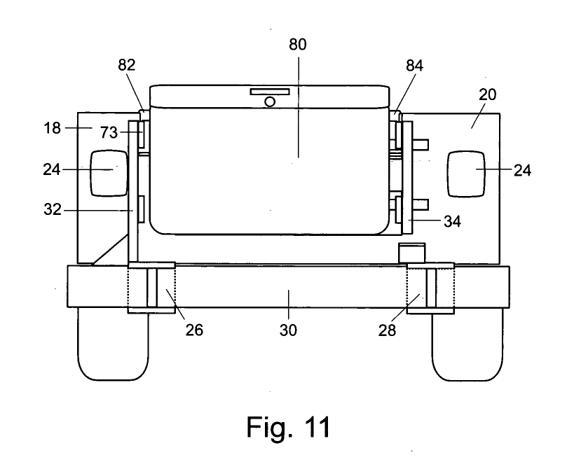

In a further embodiment of the present invention as shown in FIGS. 10, 10A and 11, wherein a stowable enclosure box 80 may be supported between the left support panel 32 and the right support panel 34 adjacent the rear door 22 of the Jeep vehicle 12. The storage container 80 in this embodiment has a pair of downwardly projecting pins 82 and 84 which are disposed diagonally apart from one another, one on each lateral side of the box 80 as represented in a plan view in FIG. 10A. The respective downwardly disposed pins 82 and 84 are arranged to fit into their respective upper left support pintle 73 and the upper right door support pintle 76 on the respective left and right support panels 32 and 34 on the rear of the Jeep vehicle 12. Such pin 82/84 and pintle 73/76 securement permits a large storage capacity which is secure and yet is removable from the rear of the Jeep 12 by its owner. The cargo carried between the left support panel 32 and the right support panel 34 may be locked therein by a latched and/or locking engagement of the spare tire support frame 40 to the right support frame 28 attached to the right hand side of the rear bumper 30 of the Jeep vehicle 12, by a locking means 86, represented in FIG. 1.

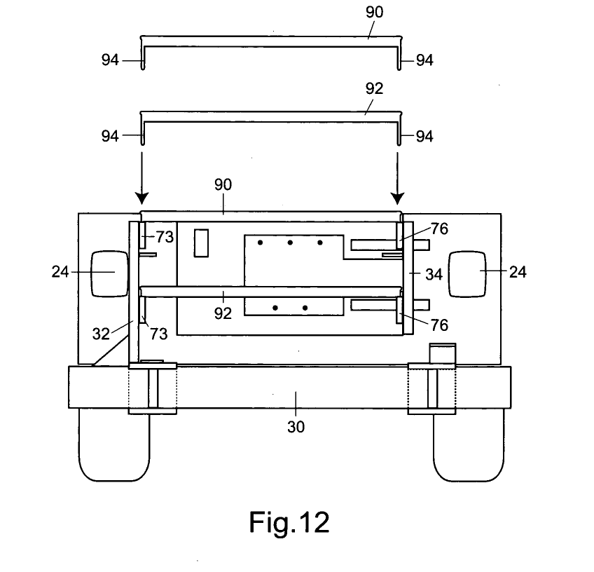

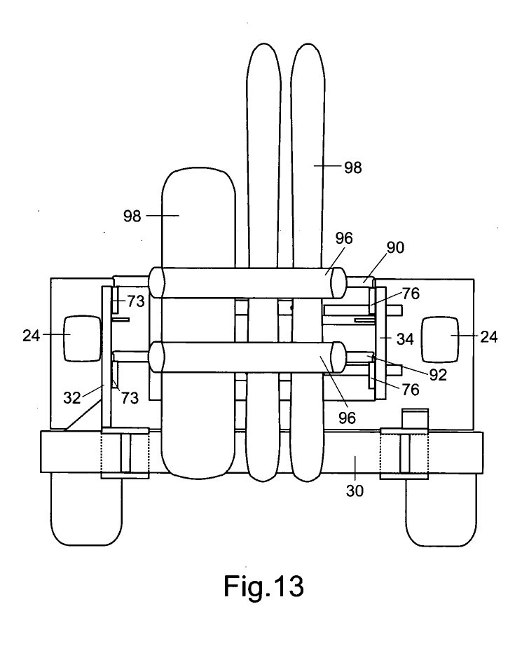

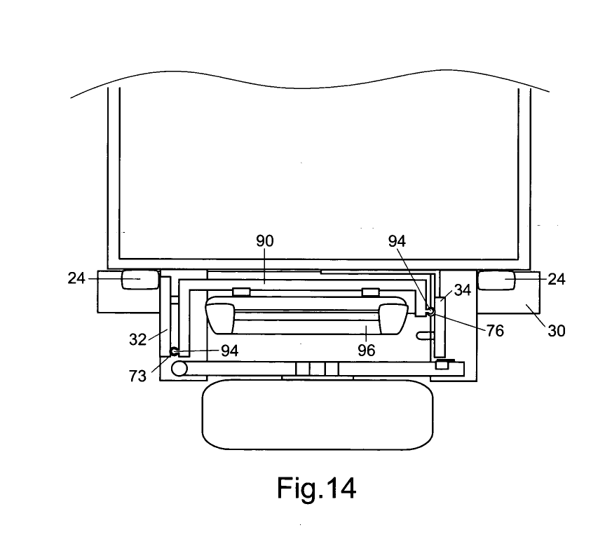

In a further embodiment of the present invention, a pair of support bars 90 and 92 are shown in FIGS. 12, 13 and 14. Each support bar 90 and 92 has a pin 94 extending off an end thereof. The pins 94 engage their respective pintles 73 and 76. A pinch frame 96 may be attached to each support bar 90 and 92, as shown in FIG. 13. The pinch frame 96 may pinchably secure sports equipment such as skis 98, as represented in FIG. 13. FIG. 14 shows a pinch frame 96 secured to the upper support bar 90, without any ski or sports equipment pinched therewithin.

1. A carrier assembly for attachment to a utility vehicle for the safe carrying and enclosure of a removable door of said utility vehicle, said carrier assembly comprising:
a left support panel and a right support panel attachable in a parallel, spaced apart manner to a rear body portion of said vehicle to define an enclosure space therebetween;
a swingable support frame pivotally secured adjacent one of said support panels to provide a rearward securement to said enclosure space; and
a mounting bracket arrangement on each opposing face of said support panels so as to engage and secure a vehicle door or storage member between said spaced apart panels.

2. The carrier assembly as recited in claim 1, wherein said mounting bracket arrangement comprises a pair of vertically spaced apart pintles, each of said pintles arranged to receive a hinge pin of a door of said vehicle.

3. The carrier assembly as recited in claim 1, wherein said mounting bracket arrangement also includes a pivotable latch, said pivotable latch arranged to engage a door handle clip of said removable door.

4. The carrier assembly as recited in claim 1, wherein said swingable support frame is arranged to carry a spare tire of said vehicle.

5. The carrier assembly as recited in claim 1, including a left support frame attachable to a portion of a frame of said vehicle for lower support of said left support panel.

6. The carrier assembly as recited in claim 1, wherein said right support frame is of “L” shape.

7. The carrier assembly as recited in claim 6, wherein said right support frame includes right panel attachment plate, said right panel attachment plate being attachable to a rear door of said vehicle.

8. The carrier assembly as recited in claim 5, wherein said right support frame attached to said bumper has a swingable support frame locking means thereon, to secure and lock said swingable support frame to said support frame on said bumper.

9. The carrier assembly as recited in claim 1, wherein said storage member comprises a storage box which is securable to said left and said right support panels.

10. The carrier assembly as recited in claim 9, wherein said storage box has an elongated pin arranged on each side thereof, so as to engage said mounting bracket arrangement on said face of each of said left and said right support panel.

11. The carrier assembly as recited in claim 10, wherein said elongated pin on each side of said box are arranged adjacent diagonally opposed corners of said box.

12. The carrier assembly as recited in claim 11, wherein said storage box comprises a frame disposed between said left and right support panels for pinchably receiving athletic equipment therebetween.

13. The carrier assembly as recited in claim 1 wherein said swingable support frame is attached to a lower frame portion of said vehicle by a bracket arranged therebetween.

14. The carrier assembly as recited in claim 2, including a set of support bars each having a pin on an end thereof, said support bars securable in said pintles.

15. The carrier assembly as recited in claim 14, including a pinch frame attachable to said support bar for pinchable support of a component of sports equipment.

16. A method of storing doors of a vehicle on a back portion of said vehicle, comprising:
attaching a pair of panels off of a rear portion of said vehicle;
attaching a set of pintles onto each of said panels; and
placing a hinge pin of said door into one of said pintles to support said door between said panels.
